(19) United States
(12) Patent Application Publication
(10) Pub. No.: US 2007/0108318 A1
(43) Pub. Date: May 17, 2007

(54) Irrigation emitter

(76) Inventors: Shay Mamo, La Jolla, CA (US); David Havazelet, Kibbutz Merchavia (IL)

Correspondence Address: DONN K. HARMS;PATENT & TRADEMARK LAW CENTER, SUITE 100, 12702 VIA CORTINA, DEL MAR, CA, 92014, US

(21) Appl. No.: 11/599,065

(22) Filed: Nov. 13, 2006

Related U.S. Application Data
(60) Provisional application No. 60/736,827, filed on Nov. 14, 2005.

(51) Int. Cl. B05B 15/00

(52) U.S. Cl. 239/542

(57) ABSTRACT

A fluid emitter adapted for engagement within a malleable conduit during extrusion of the conduit. The emitter is formed of two components and has fluid labyrinth formed in a position to eliminate contact with the malleable wall of the extrusion or conduit to thereby eliminate potential variations in flow from deformation of the wall forming the conduit caused by conduit manufacturing variances. Fluid flow characteristics of pressure and volume in fluid emitted may be adjusted by mating one of a plurality of dripper caps with varying labyrinth characteristics with a single body configuration thereby minimizing inventory requirements for manufacturers.

### FIELD OF THE INVENTION

This application claims the benefit of U.S. Provisional Patent Application No. 60/736,827, filed Nov. 14, 2005. The invention herein disclosed and described relates to drip irrigation. More particularly it relates to pressure compensating and water filtering for drippers or water emitters used for irrigation which are engaged internally along lengths of water carrying malleable tubes, tapes, and conduits. The disclosed emitter features a body formed of two components which combine to form the device and to position a formed labyrinth such that it does not contact the malleable conduit in which the emitter body is engaged or the flexible membrane employed for pressure compensation and backflow prevention.

### BACKGROUND OF THE INVENTION

Drip irrigation for many years has been a cost and water reducing method of irrigating crops and landscaping. In practice, an elongated malleable conduit in the form of a pipe, plastic tube, or inflatable tape, communicates a water supply through a central passage defined by the sidewall of the conduit. Emitters are engaged to the side wall at specified distances and communicate fluid through the side wall along the length of the conduit from the central passage on the interior to the plants or soil adjacent to the exterior of the sidewall.

Such emitters have generally been engineered in recent years to be fairly accurate in flow and pressure compensation. However, with the global economy which has developed in the last decade, a problem has begun to occur in the industry with regard to maintaining the specified flow rates from emitters designed for internal mounting in flexible conduits.

Within the global economy manufacturers of different components and raw materials for emitters are often separated by continents as well as borders. The producer of the raw material melted to extrude the conduit may be in one country or locale, whereas the manufacturer actually extruding the conduit using those raw materials may be located in another country or venue.

The same problem is occurring with the components employed to assemble the emitters adapted to be engaged in the flexible plastic conduit during extrusion. The manufacturer of the raw material used for injection molding of one or a plurality of assembled components for the emitter might be located in one country or venue which is widely separated from the injection molder who uses those raw materials. The problem on the emitters is exacerbated when the emitters themselves are assembled from various components manufactured by multiple vendors using multiple supply sources for raw material in the molding or extrusion process.

The result of this plurality of raw material suppliers in a plurality of locales, providing a plurality of different emitter components and tubing manufacturers operating in multiple venues, has gradually caused problems with the assembled emitters and tubing reaching the designed specified flow rates, backflow prevention, and pressure compensation. The variation in specifications increases radically to a total variation outside design specifications when many or all of the different parts for such systems originate from different manufacturers. The individual structural variations of the components that might be within tolerance, combined with structural variations of the flexible tubing or conduit which also may be within tolerance, combined with the variations in the materials supplied by other manufacturers which are used to injection mold the parts, act to achieve a sum of tolerances that frequently causes the assembled emitters and tubing to vary widely in their final performance. Such variances from acceptable specifications caused by this plurality of venues, suppliers, and manufacturers is becoming a growing problem in the industry.

One especially vexing problem can easily occur if tubing or flexible conduit engaged to the assembled emitter is produced from raw materials that are too malleable or too easily deformed during temperature variations. The same is true of the components assembled to make the emitter bodies mounted in the tubing. Should the raw materials be at one end of the allowed tolerance and the injection molding also be at the extreme end of an allowed tolerance range, the resulting assembled component will undoubtedly vary widely depending on the material supplier and extruder.

One chief element of the construction of conventional emitters which causes one of the most vexing problems currently plaguing an industry with many varied suppliers and manufacturers occurs with the cooperative engagement of the emitter labyrinth, formed on the exterior of an assembled emitter body, with the sidewall forming the malleable tubing. If the tubing is too soft or reacts to temperature changes, it can actually deform into or deflect into the small serpentine path of the labyrinths formed on the exterior surface on such emitters. Deflection or deformation of the tubing sidewall to interfere with fluid flow in the labyrinth can cause widely varying flow rates from the resulting assembled tubing and emitters. Still further, if a flexible membrane is employed within the emitter body for pressure compensation and/or anti-siphon properties, contact of the membrane with any portion of the labyrinth can cause the same problems noted as the membrane contacting the malleable tubing.

Another problem can arise with the expansion and contraction rates of the tubing being such that heat or cold causes the malleable tubing sidewall engaging the exterior of the emitter body to deform and again inhibit flow through the small passages of the external labyrinth conventionally placed on many currently employed emitters fused to the sidewall of such tubing. Further, the emitter body itself can end up too large or too small from the different tolerances employed by the various manufacturers of the raw material or assembled body components. This too can cause the sidewall forming the tubing to inhibit flow in the exterior formed labyrinth in some cases. In other cases where the sum of the manufacturing variations yields emitters that are too small, the flow can be radically above the desired rate if the sidewall forming the tubing is positioned too far from the exterior of the labyrinth to seal it for proper flow rates.

As such, there is an unmet need for a drip irrigation emitter that may be assembled from parts or components to allow for different flow rates. Such an emitter design should prevent the above-mentioned problems that are now inherent in assembled emitters where a global economy dictates that material and component suppliers may be widely dissipated and may compound the total deviations or variances on the final assembled emitter. Such an emitter should especially address the problem noted with placing the labyrinth on the exterior of the assembled emitter body and using the malleable sidewall of the tubing as one wall of the labyrinth and inherent problems achieving proper flow rates therethrough due to component and temperature variances. The finished emitter component produced should provide for production of a wide variety flow rates of assembled emitter bodies all of which can be mounted in sealed engagement with the extruded flexible tubing.

With respect to the above description, before explaining at least one preferred embodiment of the invention in detail, it is to be understood that the invention is not limited in its application to the details of construction and to the arrangement of the components and/or steps set forth in the following description or illustrated in the drawings. The various apparatus and methods of the invention herein described and disclosed are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other devices, methods and systems for carrying out the several purposes of the present disclosed device. It is important, therefore, that the objects and claims be regarded as including such equivalent construction and methodology insofar as they do not depart from the spirit and scope of the present invention.

Further objectives of this invention will be brought out in the following part of the specification, wherein detailed description is for the purpose of fully disclosing the invention without placing limitations thereon.

### SUMMARY OF THE INVENTION

The device herein disclosed and described provides for an assembled irrigation emitter that overcomes the shortcomings of previous designs of molded emitters providing filtering, pressure compensation and backflow prevention, where the labyrinth is positioned on the outside circumference of the assembled emitter where contact with malleable tubing is possible, or in contact with internal flexible seals. The disclosed device does so by providing a dripper body that is engageable with a body cover to yield an emitter having a curved sidewall adapted for easy engagement with flexible tubing during extrusion. The dripper body is adapted on one side of its center axis for engagement with the flexible tubing and on the other side with the body cover. The body cover has the labyrinth formed on a side surface that faces the dripper body, rather than on the opposite side surface that engages the sidewall of the extruded flexible tubing. The dripper cap can be formed with a variety of different labyrinths such that the flow rate of the final assembled dripper can be varied to meet the desired ultimate location for the tubing and emitters. However, placing the labyrinth on the dripper cover such that it is internal to the assembled emitter virtually eliminates potential problems from soft or malformed tubing inhibiting emitter flow by blocking or constricting labyrinth paths. The engageable dripper body has a filter formed on its input side wherein water is communicated from the conduit. The device is much smaller than the emitter body and consequently cheaper to manufacture and various configurations can be stocked to easily change the flow and filtering characteristics of the engaged emitter body during manufacture.

The perimeter of the dripper body device is adapted for sealed engagement into any emitter having an aperture adapted for sealed engagement thereon. Consequently, once the emitter body is formed to engage the disclosed device, any number of the dripper devices can be engaged with a single style of emitter body to change its flow and compensation characteristics at manufacture without the need to remold the body.

On the opposite side of the dripper body which feeds filtered water to the emitter body is formed a seat for a flexible membrane which is sandwiched between the emitter body and the device once it is engaged into the aperture of the emitter body. The membrane can be varied as to thickness and flexibility during manufacture of the emitter and operatively engaged when the device is engaged with the emitter. Changing the thickness or flexibility of the planar member provides the ability to change the pressure compensating characteristics of the emitter without remolding it. Further, the side surface of the device provides the seat for the flexible membrane to prevent backflow when fluid pressure in the conduit ceases.

In making the device variable as to flow characteristics by simply changing the labyrinth dimensions, great flexibility is provided as to manufactured characteristics with savings in time and cost. A plurality of differently configured dripper caps adapted for operative engagement with a single style of dripper body to change characteristics of flow without the need to remold the dripper body itself greatly reduces inventory requirements of the assembled device while concurrently increasing options to the manufacturer and customer as to a final configuration of the mounted emitter.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships, to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

In this respect, before explaining at least one embodiment of the invention in detail, it is to be understood that the invention is not limited in its application to the details of construction and to the arrangement of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

It is an object of this invention to make drip emitters highly customizable as to filtering and fluid flow characteristics without the need to remold the body of the emitters.

It is another object of this invention to allow for emitters to be easily adapted to different flow rates by assembly of cooperative components.

Yet another object of this invention is the provision of an emitter formed from components which places the fluid labyrinth out of contact with the malleable sidewall forming the tubing in which the emitter mounts, thereby obviating the need for tubing sidewalls to provide a seal on one side of the labyrinth and thereby eliminating the noted problems with such a construction.

Yet another object of this invention is the provision of an emitter formed from components which places the fluid labyrinth out of communication with any flexible membrane employed within the emitter to thereby preclude the membrane from interfering with fluid flow in the labyrinth.

The foregoing has outlined some of the more pertinent objects of the invention. These objects should be construed to be merely illustrative of some of the more prominent features and applications of the intended invention. Many other beneficial results can be attained by applying the disclosed invention in a different manner or by modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings wherein the detailed description is for the purpose of fully disclosing the invention without placing limitations thereon.

### BRIEF DESCRIPTION OF THE FIGURES

FIG. 1 depicts an exploded view of the disclosed emitter device showing the emitter body in exploded view dripper cover and dripper body with the flexible membrane sandwiched therebetween.

FIG. 2 shows an exploded view from the opposite side of FIG. 1 depicting the formed labyrinth in the surface of the dripper cover that mates to the dripper body to place the labyrinth internal to the assembled emitter.

FIG. 3 depicts a view of the dripper body portion from the side opposite the side mating to the dripper cover.

FIG. 4 shows the side of the dripper body portion of the emitter which engages with the labyrinth side of the dripper cover.

FIG. 5 is a side view of the dripper cover portion showing the labyrinth recessed therein.

FIG. 6 is a perspective side view of the dripper cover showing the side which forms the exterior wall of the formed emitter which mates to the flexible conduit wall when the body and cover are assembled.

FIG. 7 is a side view of FIG. 6.

FIG. 8 is a perspective view of the mating side of the dripper body portion which mates to the side of the dipper cover having the labyrinth formed therein.

FIG. 9 depicts an exploded view of another mode of the disclosed device similar to that of FIG. 1 showing a portion of the labyrinth formed on the dripper cover which mates to a corresponding portion formed upon the dripper body and spaced from contact with the internal membrane.

FIG. 10 shows the emitter of FIG. 9 from an opposite view showing the mating portion of the labyrinth formed in the dripper body.

FIG. 11 depicts the mode of the device of FIG. 9 showing the two components assembled into an emitter using means for engagement of the dripper cap and dripper body.

FIG. 12 is a slice through FIG. 11 showing the labyrinth formed from the mated surfaces of the dripper cap and dripper body and thereby avoiding contact with the malleable tube which engaged the external surface of the formed emitter.

FIG. 13 is a slice through the opposite side from FIG. 12.

### DETAILED DESCRIPTION OF THE PREFERRED EMBODIMENTS OF THE INVENTION

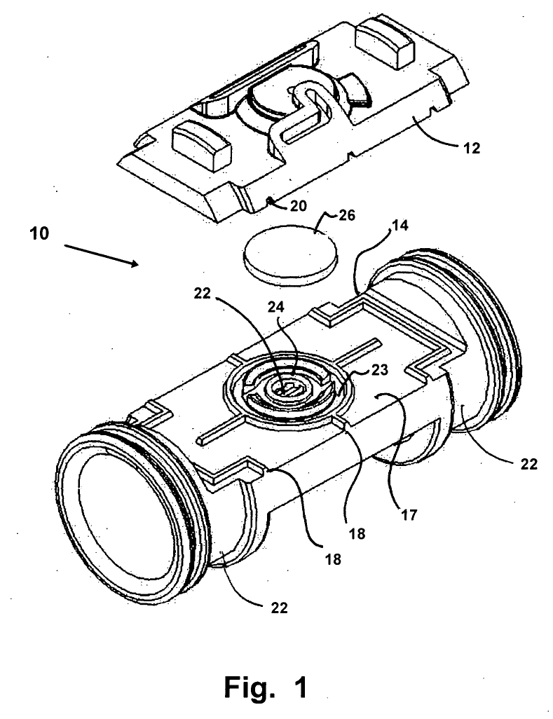

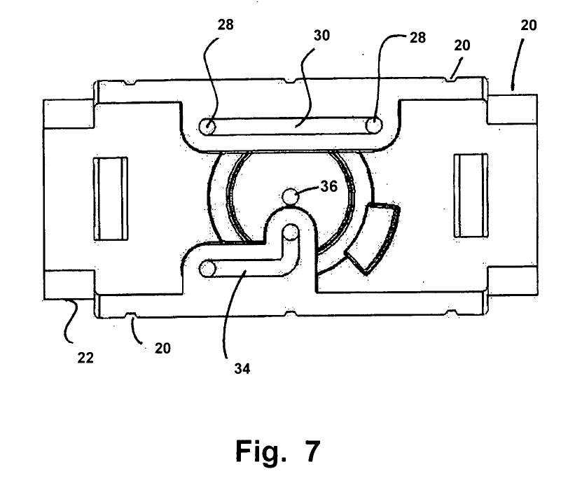

Referring now to the drawings, FIGS. 1-13 depict the various embodiments and engagements of the disclosed apparatus and device producing an assembled emitter device 10 that can be customized for flow characteristics, yet eliminate the problems inherent where many manufacturers are involved in making the raw materials and various components intended for a final tubing and emitter assembly.

The emitter device 10 features a dripper cap 12 available in a plurality of flow configurations, which is adapted for engagement to a properly configured dripper body 14. The dripper cap 12 can be manufactured in a number of configurations as a means to adjust fluid flow rates by changing dimensional characteristics of a labyrinth 13, including one or a combination of characteristics from a group of dimensional characteristics including total aggregate length of said labyrinth 13, diameter of said labyrinth 13, and number and length of individual segments ending at turns in the labyrinth 13. The engagement surface 15 of the dripper cap 12 is adapted for sealed engagement to a sealing surface 17 formed on the dripper body 14 and which is adapted for sealed engagement to the dripper cap 12 and to provide a sidewall to the labyrinth 13. Changing the flow rates of the labyrinth 13 in the above noted fashion thereby provides means to adjust the fluid flow characteristics of an ultimately assembled emitter 10 which is then engaged internally with the internal sidewall forming a flexible tubing or conduit.

Means for sealed engagement of the cap 12 to the body 14 to position the labyrinth 13 internally between the engagement surface 15 and the sealing surface 17 can be provided in a number of fashions as would occur to those skilled in the art, with a particularly preferred such means being depicted with planar engagement surface 15 mating to the sealing surface 17 using the ridges 18 formed on one of the surface adapted for sealed and compressed engagement into reciprocal notches 20 on the other. As shown, the ridges 18 and notches 20 also provide means to co-operatively engage the dripper cap 12 to the dripper body 14 in a final assembled component. Essentially the two components would snap together and can be formed during the molding process and the snap together engagement eliminates the need for adhesive and allows for the device 10 to be assembled on-site allowing customization as required. This allows the user to employ a cap 12 having the fluid flow characteristics desired for the site of use to be engaged to a single body component 14. Such a user assembly allows for a kit or set of caps 12 each having different fluid flow characteristics provided by different labyrinths 13 to be made available, all engageable to a body 14. The user can pick the cap 12 with the desired flow characteristics and assemble the device 10 or plurality of devices 10 for engagement to the conduit. Of course other means for cooperative engagement that will hold the two components together can be used such as adhesive, sonic welding, heated fusion, using a pressure fit by means of an undercut, or any other means for holding the dripper body 14 to the dripper cap 12 which would occur to those skilled in the art, and all are anticipated by this application.

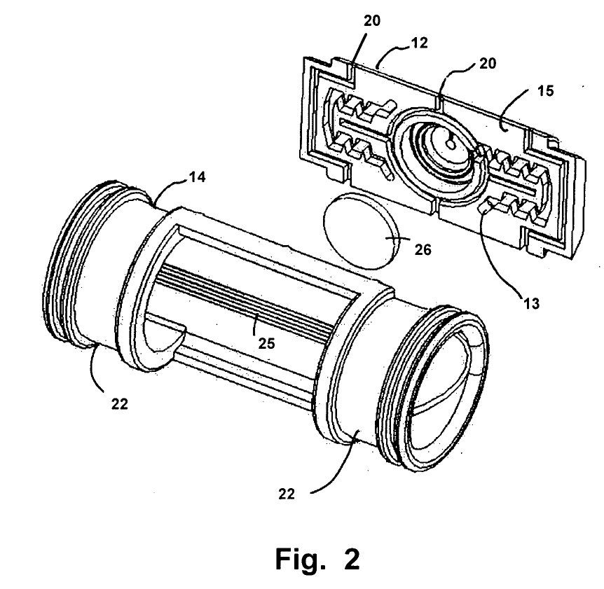

Additionally, the ridges 18 and notches 20 shown in FIG. 2 also provide a registration means to operatively position the two components in the proper engagement to provide both a seal and proper fluid flow through the various orifices and channels to the pool 22 which communicates through a formed passage in the tubing or conduit wall to which the device 10 is engaged during extrusion of the tubing. This allows for easy and accurate assembly of any of a plurality of caps 12 to a body 14.

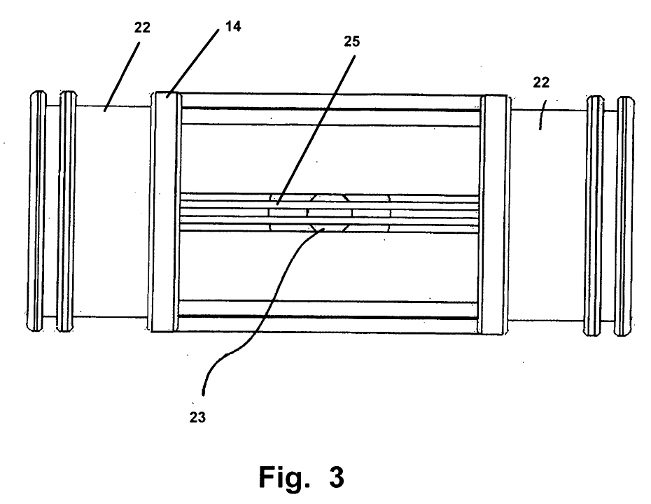

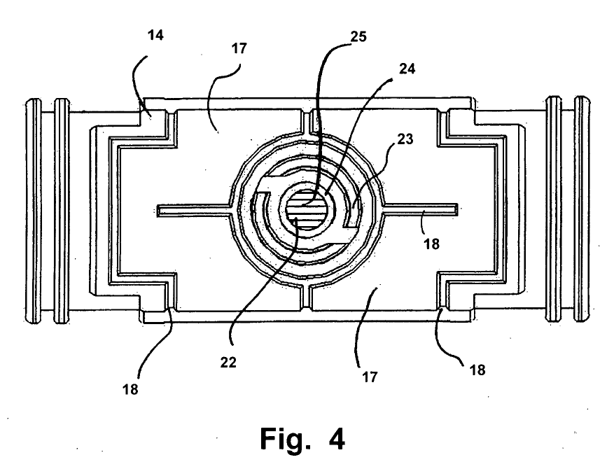

Additionally as seen in FIG. 3 there is a view of the dripper body 14 portion of the device 10 from the side opposite the side mating to the dripper cap 12. A center aperture 23 with a filter 25 therein, communicates through the dripper body 14 to the sealing surface 17 side of the body 14, shown in FIG. 4. Fluid communicated therethrough under pressure flows past a sealing ring 24 formed on the dripper body 14 and under the flexible seal 26 into the first section of the labyrinth 13 shown in FIG. 5, which communicates with outer ring 23. At the distal end of the first section of labyrinth 13, fluid is communicated through passage 28 to a conduit 30 which communicates with a second leg of labyrinth 13 through a second passage 28 shown in FIG. 5.

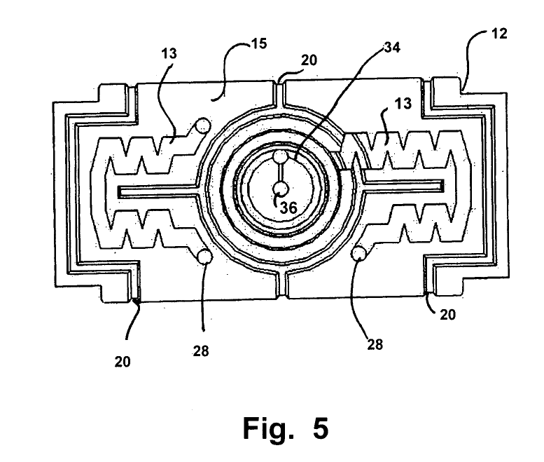

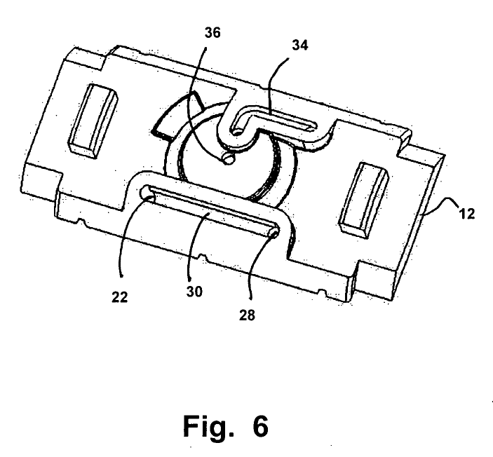

FIG. 6 shows the exterior surface of the dripper cap 12 showing the side which forms the exterior wall of the formed emitter device 10 when engaged to the body 14 and which mates to the flexible conduit wall when the body and cover are assembled and operatively engaged within and against the interior sidewall of a flexible style fluid conduit. Fluid from the distal end of the second leg of labyrinth 13 is communicated to the compensation chamber 34 and thereafter through exit aperture 36 whereafter the fluid is communicated to the pools 22 shown in FIG. 4, for communication through the malleable sidewall of an engaged flexible-tubing or conduit to which the device 10 is adapted for engagement.

As can be seen from the drawings and discerned from the disclosure, the assembled emitter device 10 can be configured for desired flow rates by changing the dripper cap 12 to one having the proper aforementioned characteristics of the labyrinth 13 at the proper diameter and number of turns, to achieve the desired flow rate when combined with the tubing during extrusion thereof. However, since the labyrinth 13 does not depend on a seal with the malleable tubing conventionally employed with such devices 10, which can vary in hardness, stiffness, size, and other properties, manufacturing variances in such malleable tubing which conventionally play havoc with emitting devices 10 having the labyrinth 13 on an exterior surface are eliminated. The device thus may be assembled for any desired flow rate and renders a highly accurate fluid flow from the flexible conduit in which it engages, no matter how many vendors are involved in the process of component manufacture. Thus, a manufacturer may provide highly customizable emitters to clients by simply varying the dripper cap 12 engaged to a single dripper body 14 and engaging the assembled device 10 operatively in the flexible conduit. One body 14 style may be engaged with any of a plurality of different caps 14 having different flow characteristics produced by the aforementioned labyrinth 13 configuration, thereby reducing inventory requirements.

Further, the assembled device 10 provides both pressure compensation through the operation of the compensation chamber 34, which will force the flexible seal 26 to a sealed position during periods which fluid pressure in the compensation chamber 34, on the other side of the seal 26, is higher than desired. Further, the seal provides a means for back flow prevention through the seal of the flexible seal 26 on the sealing ring 24 when fluid pressure ceases to raise it above the sealing ring 24 and allow fluid into the labyrinth 13. The result is that the entire conduit of engaged emitters will flow evenly at the designed pressure, at the same time and rate, and the conduit itself will not drain once fluid pressure ceases. This engagement of the seal 26 upon cessation of fluid flow thereby provides a means to alleviate air in the conduit housing the emitter devices 10, contamination of the water supplying the conduit, and excess startup times conventionally required while air clears from the conduit in which the emitter devices 10 are operatively engaged.

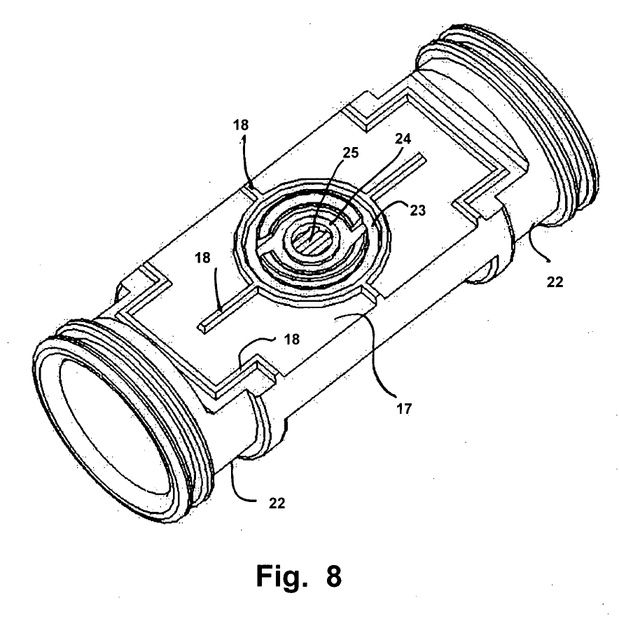

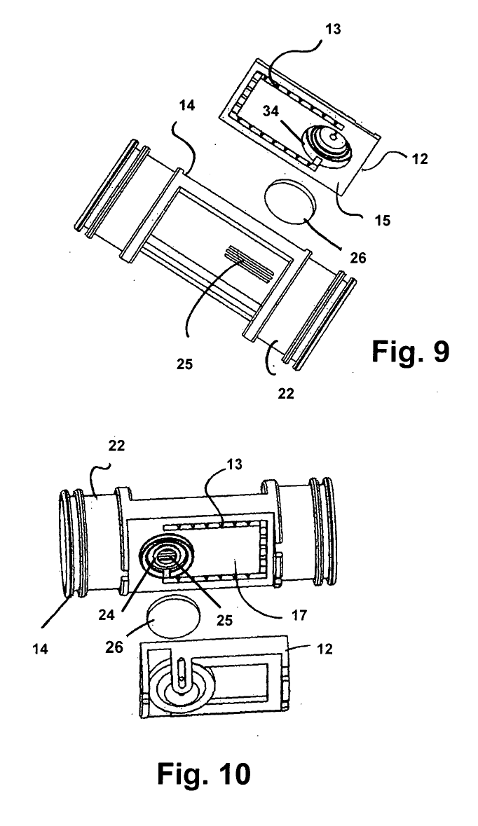

Another mode of the device 10 is shown in FIGS. 9 through 13 wherein the labyrinth 13 is formed in a manner to avoid contact with both the flexible seal 26 and the malleable conduit or tubing in which the device will be engaged. FIG. 9 also shows an exploded view depicting a portion of the labyrinth 13 formed on engagement surface 15 of the dripper cap 12 which mates to a corresponding portion of the labyrinth being formed upon sealing surface 17 of the dripper body 14 as shown in FIG. 10.

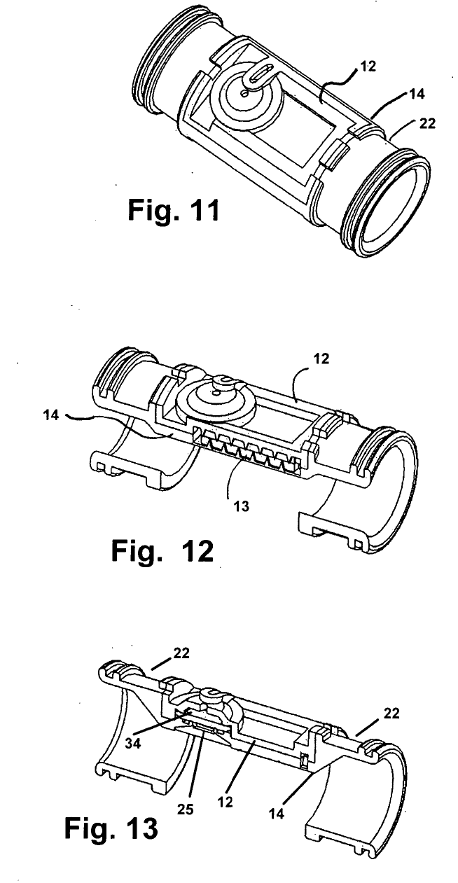

Once the two components are assembled as shown in FIG. 11 the passageway defining the labyrinth 13 is formed from the two matching recesses formed onto the mated surfaces of the dripper cap 12 and dripper body 14. The resulting labyrinth 13 achieves a principal object of the invention herein, by positioning the formed labyrinth 13 in a fashion to totally avoid contact with the malleable tube or conduit when engaged therein, and also to avoid communication with the flexible seal 26 which can also cause the above noted flow problems.

Although the invention has been herein disclosed and described with respect to particular embodiments thereof, it should be realized that various changes and modifications may be made therein without departing from the spirit and scope of the invention. While the invention as shown in the drawings and described in detail herein discloses arrangements of elements of particular construction and configuration for illustrating preferred embodiments of structure and method of operation of the present invention, it is to be understood, however, that elements of different construction and configuration and other arrangements thereof, other than those illustrated and described, may be employed in accordance with the spirit of this invention. Any and all such changes, alternations and modifications, as would occur to those skilled in the art are considered to be within the scope of this invention as broadly defined in the appended claims.

Further, the purpose of the attached abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

1. A fluid emitter having a pool section adapted to communicate fluid though an aperture communicating through a conduit wall of a conduit operatively engaging said fluid emitter within, comprising:
a dripper body having a top surface and a rear surface;
a dripper cap having a bottom surface and a back surface;
a fluid labyrinth formed by a recess into said bottom surface;
means for sealed engagement of said top surface with said bottom surface thereby positioning said fluid labyrinth therebetween in an assembled said fluid emitter;
means for cooperative engagement of said dripper body to said dripper cap to form said fluid emitter, prior to insertion thereof into said conduit;
a passage communicating through said dripper body from said rear surface, to a first end of said labyrinth;
a second end of said labyrinth communicating with said pool, said passage providing communication of a pressurized fluid flow from said conduit, to said first end of said labyrinth and onto said pool; and
whereby fluid communicated to said passage from said conduit is communicated to said pool through said labyrinth which is formed without contact with said conduit, and thereafter to the exterior of said in an exiting fluid flow through an exit aperture operatively positioned therein communicating with said pool.

2. The fluid emitter of claim 1 additionally comprising:
said dripper cap, selectable from a plurality of said dripper caps having a said labyrinth formed in said bottom surface of each of said plurality;
said plurality of said dripper caps each independently engageable to said dripper body to form said fluid emitter;
members of said plurality of said dripper caps, having individual said labyrinths having differing dimensional characteristics from a group of said dimensional characteristics including one or a combination of a differing total aggregate length of said labyrinth, a differing diameter of said labyrinth, a differing number of individual segments defined by turns in said labyrinths, and a segment length of individual said segments ending at said turns in said labyrinth;
said differing dimensional characteristics determining different fluid flow rates through said labyrinth communicated from said passage, to said pool; and
assembling different individual of said members of said plurality of dripper caps, with said dripper body to yield said fluid emitter, thereby providing means to adjust a rate of said exiting fluid flow from said pool in said fluid emitter.

3. The fluid emitter of claim 1 additionally comprising:
said passage communicating through an aperture in said top surface with a lower end of a first chamber providing communication between said passage and said first end of said labyrinth;
an annular sealing ring extending from said top surface and surrounding said aperture;
a planar seal adapted on a first side to engage said annular sealing ring in a sealed engagement upon a cessation of said fluid flow from said conduit into said passage, said sealed engagement interrupting communication of said passage with said labyrinth; and
said sealed engagement providing means to prevent air communicating through said exit aperture to said labyrinth, form communicating into said conduit through said passage.

4. The fluid emitter of claim 2 additionally comprising:
said passage communicating through an aperture in said top surface with a lower end of a first chamber providing communication between said passage and said first end of said labyrinth;
an annular sealing ring extending from said top surface and surrounding said aperture;
a planar seal adapted on a first side to engage said annular sealing ring in a sealed engagement upon a cessation of said fluid flow from said conduit into said passage, said sealed engagement interrupting communication of said passage with said first end of said labyrinth; and
said sealed engagement providing means to prevent air communicating through said exit aperture to said labyrinth, from communicating into said conduit through said passage.

5. The fluid emitter of claim 3 additionally comprising:
a pressure compensation chamber defined by a second side of said planar seal opposite said first side, and an upper portion of said first chamber;
said pressure compensation chamber providing sole communication between said second end of said labyrinth and said pool;
said pressurized fluid flow communicated to said compensation chamber from said labyrinth from said conduit, communicating a force upon said second side of said planar seal; and
said force urging said planar seal to said sealed engagement when said pressurized fluid flow exceeds a predetermined pressure thereby providing means to maintain said exiting fluid flow below said predetermined pressure.

6. The fluid emitter of claim 4 additionally comprising:
a pressure compensation chamber defined by a second side of said planar seal opposite said first side, and an upper portion of said first chamber;
said pressure compensation chamber providing sole communication between said second end of said labyrinth and said pool;
said pressurized fluid flow communicated to said compensation chamber from said laby from said conduit, communicating a force upon said second side of said planar seal; and
said force urging said planar seal to said sealed engagement when said pressurized fluid flow exceeds a predetermined pressure thereby providing means to maintain said exiting fluid flow below said predetermined pressure.

7. The fluid emitter of claim 1 additionally comprising:
a filter formed in said body at a communication of said passage with said rear surface of said body.

8. The fluid emitter of claim 2 additionally comprising:
a filter formed in said body at a communication of said passage with said rear surface of said body.

9. The fluid emitter of claim 3 additionally comprising:
a filter formed in said body at a communication of said passage with said rear surface of said body.

10. The fluid emitter of claim 4 additionally comprising:
a filter formed in said body at a communication of said passage with said rear surface of said body.

11. The fluid emitter of claim 5 additionally comprising:
a filter formed in said body at a communication of said passage with said rear surface of said body.

12. The fluid emitter of claim 6 additionally comprising:
a filter formed in said body at a communication of said passage with said rear surface of said body.

13. The fluid emitter of claim 1 wherein said means for sealed engagement of said top surface with said bottom surface comprises:
a ridge extending from one of said top surface or said bottom surface; and
said ridge adapted for sealed engagement within a notch formed in the other of said top surface or said bottom surface.

14. The fluid emitter of claim 2 wherein said means for sealed engagement of said top surface with said bottom surface comprises:
a ridge extending from one of said top surface or said bottom surface; and
said ridge adapted for sealed engagement within a notch formed in the other of said top surface or said bottom surface.

15. The fluid emitter of claim 3 wherein said means for sealed engagement of said top surface with said bottom surface comprises:
a ridge extending from one of said top surface or said bottom surface; and
said ridge adapted for sealed engagement within a notch formed in the other of said top surface or said bottom surface.

16. The fluid emitter of claim 4 wherein said means for sealed engagement of said top surface with said bottom surface comprises:
a ridge extending from one of said top surface or said bottom surface; and
said ridge adapted for sealed engagement within a notch formed in the other of said top surface or said bottom surface.

17. The fluid emitter of claim 5 wherein said means for sealed engagement of said top surface with said bottom surface comprises:
a ridge extending from one of said top surface or said bottom surface; and
said ridge adapted for sealed engagement within a notch formed in the other of said top surface or said bottom surface.

18. The fluid emitter of claim 6 wherein said means for sealed engagement of said top surface with said bottom surface comprises:
a ridge extending from one of said top surface or said bottom surface; and
said ridge adapted for sealed engagement within a notch formed in the other of said top surface or said bottom surface.

19. The fluid emitter of claim 7 wherein said means for sealed engagement of said top surface with said bottom surface comprises:
a ridge extending from one of said top surface or said bottom surface; and
said ridge adapted for sealed engagement within a notch formed in the other of said top surface or said bottom surface.

20. The fluid emitter of claim 8 wherein said means for sealed engagement of said top surface with said bottom surface comprises:
a ridge extending from one of said top surface or said bottom surface; and
said ridge adapted for sealed engagement within a notch formed in the other of said top surface or said bottom surface.
